(19) United States
(12) Patent Application Publication
(10) Pub. No.: US 2010/0188644 A1
(43) Pub. Date: Jul. 29, 2010

(54) METHOD AND DEVICE FOR PROJECTING AN IMAGE ON A PROJECTION SURFACE

(75) Inventors: Juergen Kraenert, Jena (DE); Wolfram Biehlig, Jena (DE); Andreas Zintl, Arnstadt (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: LDT LASER DISPLAY TECHNOLOGY GMBH, Jena (DE)

(21) Appl. No.: 12/596,102

(22) PCT Filed: Apr. 18, 2008
(86) PCT No.: PCT/DE2008/000647

§ 371 Date: Oct. 15, 2009

(30) Foreign Application Priority Data
Apr. 19, 2007 (DE) 102007019017.6

(51) Int. Cl. G03B 21/28

(52) U.S. Cl. 353/99

(57) ABSTRACT

A method and a device for projecting an image made up of pixels onto a projection surface, including a variable-intensity light source emitting a light beam and a decoupling device, and a deflection device directing the light beam onto a projection surface. In The light beam(s) are deflected such that the beams strike mirror facets of the polygonal mirror twice in a row. The diameter at which the beam strikes the first mirror facet of the polygonal mirror is adjusted such that it is dimensioned to practically not be cut by the facet edges. At the second strike, the light beam always intersects the mirror facet at the same location.

### PRIORITY CLAIM

The present application is a National Phase entry of PCT Application No. PCT/DE2008/000647, filed Apr. 18, 2008, which claims priority from German Application Number 102007019017.6, filed Apr. 19, 2007, the disclosures of which are hereby incorporated by reference herein in their entirety.

### BACKGROUND OF THE INVENTION

The invention relates to a method and an apparatus for projecting an image onto a projection surface, which image is constructed from pixels, having at least one light source that emits a light beam and whose intensity can be varied and a decoupling device downstream of the fiber, such as is disclosed, for example, in DE 102004001389 B4, and a following deflecting device that guides the light beam onto a projection surface. The deflecting device substantially consists of a scanner unit, which consists of a polygonal mirror, a lens or lens system, a suitable arrangement of deflecting mirrors, a shutter and a galvanometer mirror.

For the purpose of video projection, the image information and color information of various pixels of a video image are respectively applied to a parallel or virtually parallel light beam. In all known systems for imaging with the aid of lasers deflection is performed mechanically. Deflection systems are known both from laser printing technology and from laser video technology. It is common to these technologies that, in order to display an image, they illuminate a matrix arrangement of pixels in a grid by means of a beam of laser light rays or another parallel light beam. The light beam is used in this case to scan a surface to be illuminated over a plurality of lines in the so-called line direction. This surface to be illuminated can be, for example, a suitable projection surface such as are used as large area display and projection systems of high image quality in the multimedia sector in the case of large scale events or as advertising media, or they can be a flat screen or else spherical projections such as, for example, into the dome of a planetarium, or a partially cylindrical surface as in the case of some flight simulators.

DE 43 24 849 C2 discloses a laser video system in the case of which the light bundle is modulated with a different color and brightness at every instant. While it is illuminating different pixels of the surface by scanning, it is provided with the information content desired for each illuminated pixel. The result of this is a color image on the surface. A laser video system of this type requires an exceptionally high deflection rate of the light beam because of the large number of pixels. A rapidly rotating polygonal mirror is used in this case for the line deflection, and a pivoting mirror is used for the image deflection. Also described in DE 43 24 849 C2 is a transformation optics for line and image deflection of the type that is intended to vary the scanned image and, in particular, to enlarge it. It has emerged with regard to such transformation optics that, in the case of flat screens, these can be corrected in a suitable way with reference to chromatic aberrations and image distortions only by observing the condition that, for example, the emergence angle and the tangent of the incidence angle are at a fixed ratio to one another for illuminating each pixel. Consequently, the compensation is performed by an appropriate transformation optics. However, a certain drop in brightness and edge discoloration of the image are not corrected in this case. In some instances, slight reddish or greenish discolorations occur at the left-hand or right-hand image edge, and vice versa.

EP 1 031 866 A2 describes a relay optics for a deflection system, and a corresponding deflection system, both of which are to be less complicated and can be easily optimized including, in particular, with reference to chromatic aberrations. A solution is described herein that provides in a single optical system a mirror surface which reflects at least once the light beam falling from the prescribed location of the first scanning device through the single optical system acting as a first optical system, and thereafter is directed back to the first optical system then as a second optical system. Instead of two optical systems, use is made only of a single optical system that acts firstly as a first optical system and then as a second optical system. However, it has not been possible to implement this solution.

Various published patents and references in the literature disclose solutions for correcting chromatic aberrations by means of various lens systems, and the color correction of the objectives. Correction of the chromatic aberration is effected in U.S. Pat. No. 5,838,480 A by the cylindrical lenses downstream of the polygonal mirror, and a diffractive element.

JP 2001194608 A describes a diffraction element in the form of a cover glass in conjunction with a protective system, that is arranged upstream of the polygonal mirror.

Again, JP 20011350116 A describes an oblique arrangement of a diffractive element between the polygonal mirror and lens system, the intention of which is to avoid chromatic differences upon enlargement without the occurrence of ghost images or curves in the case of line scanning.

Also described in DE 69417174 T2 (page 19, line 23, to page 20, line 29 and page 20, lines 18-20) is a color image projection device in the case of which an optical delay is used in one of the exemplary embodiments described in order to achieve a symmetry of 180° phase shifting of two light beams.

DE 4041240 A1 (page 11, lines 23-31) furthermore discloses a projection lens system that attains an aberration correction, in particular at the edges of the screen.

However, none of the solutions prevents a possible occurrence of a drop in brightness and edge coloration at the edge of the image in the case of the type of laser video systems described at the beginning.

A solution to this problem is disclosed in DE 102004001389 B4. However, this has the disadvantage that it cannot be applied to a fiber pair, but this is a requirement for being able to write two lines simultaneously in the laser projection and achieving higher resolutions. A fiber pair in the meaning of the present invention consists of two closely adjacent fiber cores. Emerging from the two fiber cores in each case is a divergent and modulated light beam which are imaged together via the fiber decoupling.

### SUMMARY OF THE INVENTION

It is therefore an object of the invention to improve the generic method, known from the prior art, and the video system such that the edge drop (better brightness homogeneity in the image) and the edge discolorations in the video projection are minimized by means of a laser, and the brightness curve in the projected image is considerably improved.

The object is achieved according to the invention by a method in the case of which at least one light beam emerging from an optical fiber strikes the mirror facets of the polygonal mirror.

In an embodiment of the inventive solution, the light beam(s) is/are directed downstream of a fiber decoupling unit such that it/they strikes/strike mirror facets of the polygonal mirror twice in succession. The diameter with which the beam(s) strikes a first mirror facet of the polygonal mirror is dimensioned such that said diameter is practically not cut, or cut only slightly, at the facet edges. In accordance with the invention, “slightly” is understood in this case to mean that the brightness at the image edge does not drop below a value of 70% of the image center (see also FIG. 7). In an example design, said value is approximately 1 mm. Coming from the first mirror facet, it is consequently directed for a second time, with the aid of an inventive deflecting device, onto a mirror facet of the polygonal mirror. Here, the beam diameter is set to be so large that as small a light spot as possible is attained on the projection screen. The beam diameter on the second mirror facet is limited in this case by the size of the mirror facet itself. That is to say, it is cut at the facet edges. In order to prevent the aberrations resulting thereby in the discussions to date of the prior art (edge drop and edge discolorations), by means of the inventive method the light beam is guided such that the light beam is, as it were, moved together with the rotating polygonal mirror, and therefore intersects the facet always at the same location or virtually at the same location. The application refers in this case to a “frozen beam”. Consequently, the image size (larger maximum scan angle) is simultaneously enlarged with the pixel size on the screen remaining the same, and the achievable pixel density is increased.

In various designs, the inventive method and device can be operated both with a single fiber and with a fiber pair or a larger number of fibers.

In an embodiment of the inventive deflecting device denotes a device consisting of a polygonal mirror, arranged downstream of the fiber decoupling unit, with a suitable number of mirror facets, downstream of the optical elements, such as a lens or lens system, a suitable number of deflecting mirrors that are positioned relative to one another in their arrangement and number such that in accordance with the inventive method, they guide the light beam twice onto mirror facets of the polygonal mirror, and said light beam sequentially strikes the facet 4a and, in the case of the second contact, the facet 4b, and additionally, in a suitable way, one or more arranged shutter(s). In the various embodiments, the plane mirrors or deflecting mirrors can also be arranged upstream of the lens or the lens system. Arranged downstream of the polygonal mirror is a galvanometer mirror which is positioned such that it guides the light beam onto the projection screen after the second deflection of the polygonal mirror.

The lens or lens system collimates the light beam, or focuses it onto the projection screen. The deflecting mirrors are arranged relative to one another such that, as described, they direct the light beam onto the polygonal mirror for a second time. The beam is reflected at a second mirror facet and directed onto the galvanometer mirror that, for imaging purposes, effects a deflection in, or virtually in, a vertical direction (perpendicular with reference to the plane of the paper of FIG. 1). The beam diameter on the 2nd facet corresponds approximately to the width of the mirror facet.

In addition to the abovementioned function, the lens/lens system further has a second task: depending on the position of the rotating polygonal mirror, the light beam is reflected in different directions at the 1st facet. The beam initially has the direction F1, thereafter the direction F2. The lens/lens system ensures that the point of incidence of the beam on the 2nd facet remains practically unchanged, although the latter is moved further as a consequence of the rotation of the polygonal mirror (the beam that is also moved, positions F1 and F2). The incidence angle with reference to the 2nd facet also changes simultaneously and this results in an enlargement of the horizontal scan angle in the image (corresponding to the selection of suitable mirrors), see also FIG. 5. The focal length of the lens/lens system should be selected to be at least so large that an error owing to the variable spacing from the facet surface, radial stroke from the rotation, remains negligible, see FIGS. 5 and 9.

The number and arrangement of the deflecting mirrors between the two facets can differ from the example in FIG. 1. For example, it is also possible to use a larger number of deflecting mirrors. A further design in this regard may also be gathered from FIG. 10. It is important that the two functions, that is to say the beam that is also moved and enlargement of the scan angle are maintained.

It is also possible to generalize the principle to more than 2 facet surfaces.

A further embodiment of the invention results from the combination with an additional infrared light source in order thereby to scan red-green-blue (RGB) radiation and infrared into an image. By way of example, to this end the infrared signal originating from an additional laser is injected via a dichroic mirror into the beam path of the optical fiber, for example, upstream of the 1st mirror facet in FIG. 1 or 10.

### BRIEF DESCRIPTION OF THE DRAWINGS

The invention is explained below with reference to the figures, in which:

FIG. 1 is a schematic of the principle of the inventive scanner unit for a laser assisted color image display and projection device from which the invention proceeds;

FIG. 2 is a schematic of the principle of the inventive scanner unit according to FIG. 1 as a side view, it being possible to set the angle β depending on requirements;

FIG. 3 depicts the principle of the inventive scanner unit according to FIG. 1 in a side view, the facet faces of the polygonal mirror (4) being inclined with reference to the rotation axis in a departure from FIG. 2;

FIG. 4 depicts the design of a conventional laser scanner according to the prior art in plan view;

FIG. 5 depicts the position of the light beams in the case of a polygonal mirror, for example, with 6 faces, for two consecutive instants;

FIG. 6 depicts a typical brightness characteristic in a horizontal image direction for a laser projector in accordance with FIG. 4 (conventionally);

FIG. 7 depicts a brightness characteristic for a smaller beam diameter (approximately ⅓) by comparison with FIG. 6;

FIG. 8 is an illustration of the possible enlargement of the number of pixels by larger scan angles;

FIG. 9 illustrates the beam direction in the upper figure; and illustrates the beam diameter in the lower figure; and

FIG. 10 shows an example embodiment of the inventive scanning device with 4 deflecting mirrors.

### DETAILED DESCRIPTION

In an embodiment of the inventive solution, the light beam(s) (2) is/are directed downstream of a fiber decoupling unit (3) such that it/they strikes/strike mirror facets of the polygonal mirror (4) twice in succession. The diameter with which the beam(s) (2) strikes a first mirror facet of the polygonal mirror (4) is dimensioned such that said diameter is practically not cut, or cut only slightly, at the facet edges. In accordance with the invention, “slightly” is understood in this case to mean that the brightness at the image edge does not drop below a value of 70% of the image center (see also FIG. 7). In an example design, said value is approximately 1 mm. Coming from the first mirror facet, it is consequently directed for a second time, with the aid of an inventive deflecting device, onto a mirror facet of the polygonal mirror (4). Here, the beam diameter is set to be so large that as small a light spot as possible is attained on the projection screen. The beam diameter on the second mirror facet is limited in this case by the size of the mirror facet itself. That is to say, it is cut at the facet edges. In order to prevent the aberrations resulting thereby in the discussions to date of the prior art (edge drop and edge discolorations), by means of the inventive method the light beam is guided such that the light beam is, as it were, moved together with the rotating polygonal mirror, and therefore intersects the facet always at the same location or virtually at the same location. The application refers in this case to a “frozen beam”. Consequently, the image size (larger maximum scan angle) is simultaneously enlarged with the pixel size on the screen remaining the same, and the achievable pixel density is increased.

In various designs, the inventive method and device can be operated both with a single fiber and with a fiber pair or a larger number of fibers.

One embodiment of the inventive deflecting device includes a polygonal mirror (4), arranged downstream of the fiber decoupling unit (3), with a suitable number of mirror facets, downstream of the optical elements, such as a lens or lens system (5), a suitable number of deflecting mirrors that are positioned relative to one another in their arrangement and number such that in accordance with the inventive method, they guide the light beam (2) twice onto mirror facets of the polygonal mirror (4), and said light beam sequentially strikes the facet 4a and, in the case of the second contact, the facet 4b, and additionally, in a suitable way, one or more arranged shutter(s) (8). In the various embodiments, the plane mirrors or deflecting mirrors can also be arranged upstream of the lens or the lens system (5). Arranged downstream of the polygonal mirror (4) is a galvanometer mirror (9) which is positioned such that it guides the light beam (2) onto the projection screen (10) after the second deflection of the polygonal mirror.

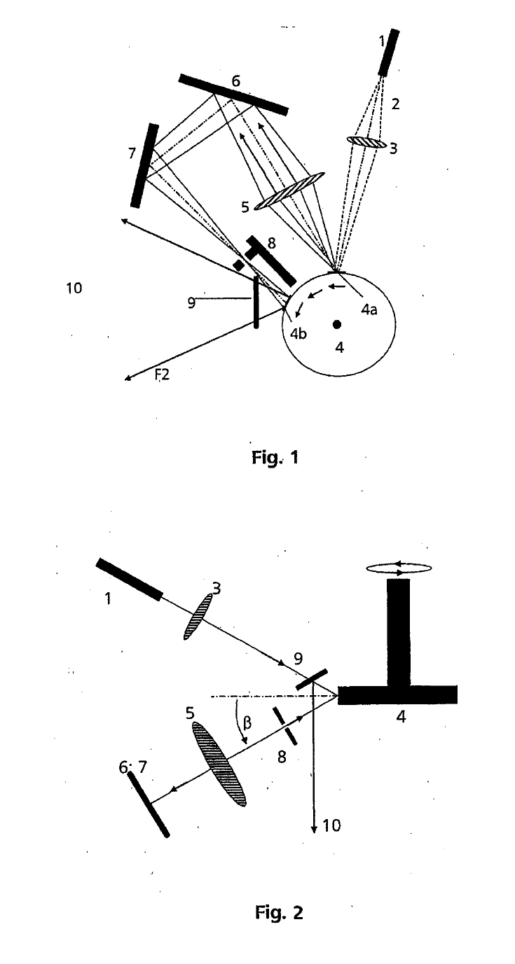

The lens or lens system (5) collimates the light beam (2), or focuses it onto the projection screen (10). The deflecting mirrors (6; 7 . . . ) are arranged relative to one another such that, as described, they direct the light beam (2) onto the polygonal mirror (4) for a second time. The beam (2) is reflected at a second mirror facet and directed onto the galvanometer mirror (9) that, for imaging purposes, effects a deflection in, or virtually in, a vertical direction (perpendicular with reference to the plane of the paper of FIG. 1). The beam diameter on the 2nd facet corresponds approximately to the width of the mirror facet.

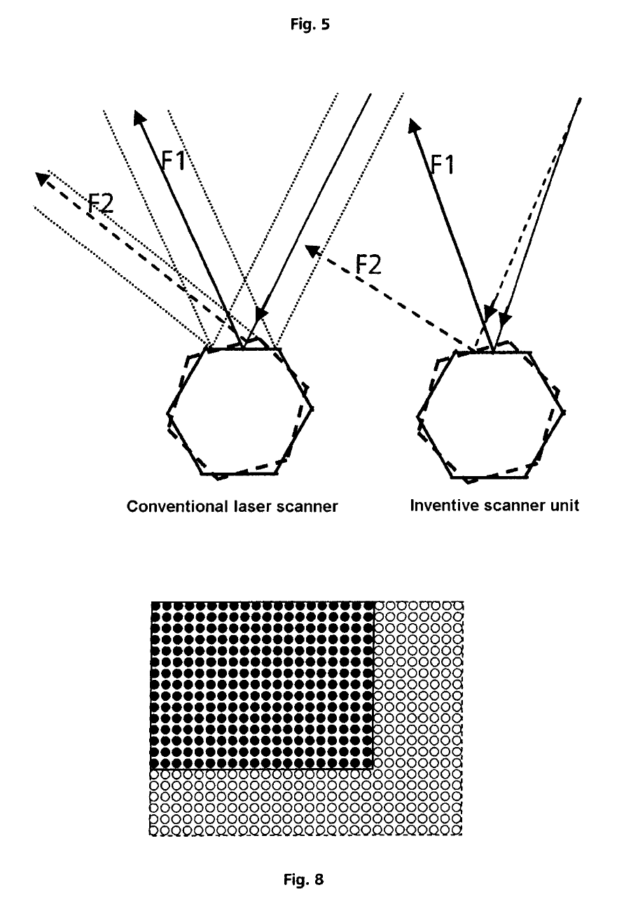

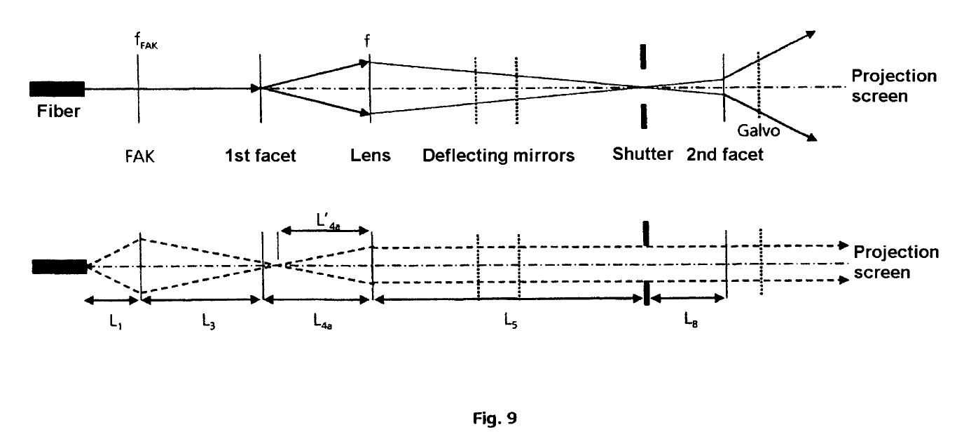

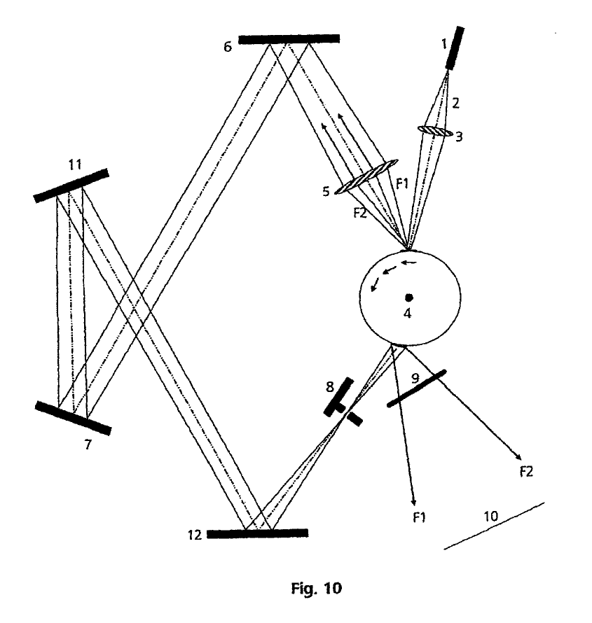

In addition to the abovementioned function, the lens/lens system (5) further has a second task: depending on the position of the rotating polygonal mirror (4), the light beam (2) is reflected in different directions at the 1st facet (4a). The beam initially has the direction F1, thereafter the direction F2. The lens/lens system (5) ensures that the point of incidence of the beam on the 2nd facet (4b) remains practically unchanged, although the latter is moved further as a consequence of the rotation of the polygonal mirror (4) (the beam that is also moved, positions F1 and F2). The incidence angle with reference to the 2nd facet also changes simultaneously and this results in an enlargement of the horizontal scan angle in the image (corresponding to the selection of suitable mirrors), see also FIG. 5. The focal length of the lens/lens system (5) should be selected to be at least so large that an error owing to the variable spacing from the facet surface, radial stroke from the rotation, remains negligible, see FIGS. 5 and 9.

The number and arrangement of the deflecting mirrors between the two facets can differ from the example in FIG. 1. For example, it is also possible to use a larger number of deflecting mirrors. A further design in this regard may also be gathered from FIG. 10. It is important that the two functions, that is to say the beam that is also moved and enlargement of the scan angle are maintained.

It is also possible to generalize the principle to more than 2 facet surfaces.

A further embodiment of the invention results from the combination with an additional infrared light source in order thereby to scan red-green-blue (RGB) radiation and infrared into an image. By way of example, to this end the infrared signal originating from an additional laser is injected via a dichroic mirror into the beam path of the optical fiber (2), for example, upstream of the 1st mirror facet (4a) in FIG. 1 or 10.

The invention is explained below with reference to the figures, in which:

FIG. 1 is a schematic of the principle of the inventive scanner unit for a laser assisted color image display and projection device from which the invention proceeds; FIG. 2 is a schematic of the principle of the inventive scanner unit according to FIG. 1 as a side view, it being possible to set the angle β depending on requirements; the light path need not lie in the plane of the polygonal mirror (4). This also becomes evident from FIG. 2. There is an angle of 2β between the fiber and lens (5) and the deflecting mirrors. This has the advantage of having a space-saving design. The deflecting mirrors are illustrated located in a plane.

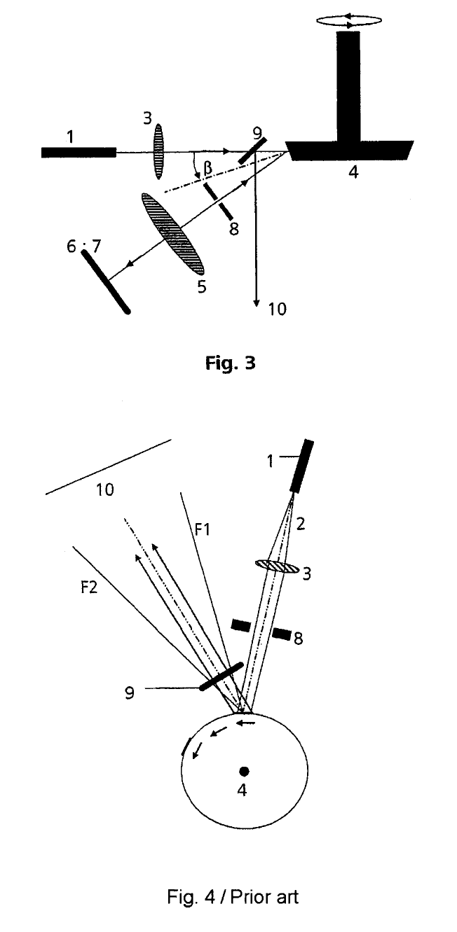

FIG. 3 shows the principle of the inventive scanner unit according to FIG. 1 in a side view, the facet faces of the polygonal mirror (4) being inclined with reference to the rotation axis in a departure from FIG. 2. The beam direction coming from the fiber and directly upstream of the galvanometer mirror (9) is perpendicular to the rotation axis of the polygonal mirror (4).

By contrast with FIG. 2, straight lines are thus scanned on a flat screen. Hyperbolas would result according to FIG. 2.

FIG. 4 shows the design of a conventional laser scanner according to the prior art in plan view; the design principle of a conventional scanner is illustrated in FIG. 4. The deflection of the lines in a horizontal direction are implemented by the rotation of the polygonal mirror, while the galvanometer mirror establishes the position of the lines in a vertical direction. Thus, the image is produced by deflection of laser beams, analogously to the electron beams in the television picture tube. Each individual facet of the polygonal mirror produces a line in the image. As a consequence of the rotation, the respective facet moves in a lateral direction through the collimated laser beam, coming from the fiber decoupling (3). Consequently, only a portion of the incident beam is reflected, and only this portion participates in the construction of the image, and the rest remains unused, FIG. 5 on the left. The fiber decoupling (3) (an achromat, as a rule) collimates the beam (2) or focuses it onto the projection screen (10). In each case, only one mirror facet is used per line (two lines in the case of a fiber pair). The beam diameter at the polygonal mirror corresponds approximately to the width of the facet.

FIG. 5 shows the position of the light beams in the case of a polygonal mirror, for example, with 6 faces, for two consecutive instants; the vignetting of the light beam is illustrated in FIG. 5. The manner in which the facet face moves through the light beam is illustrated in the left-hand partial figure (conventional laser scanner). This results in a cutting of the beam from F1 to F2.

It can be gathered from the right-hand partial figure (inventive scanner unit) that the light beam always strikes the second facet 4b at the same location, and because it is also being moved no variable cutting occurs. By contrast with the conventional scanner (left-hand figure), in the case of this scanner unit, a so-called freezing effect of the incident beam, and a change in its direction may be recognized.

How the vignetting occurs may be understood from the left-hand figure. The delimitation of the light beam is illustrated here by dots.

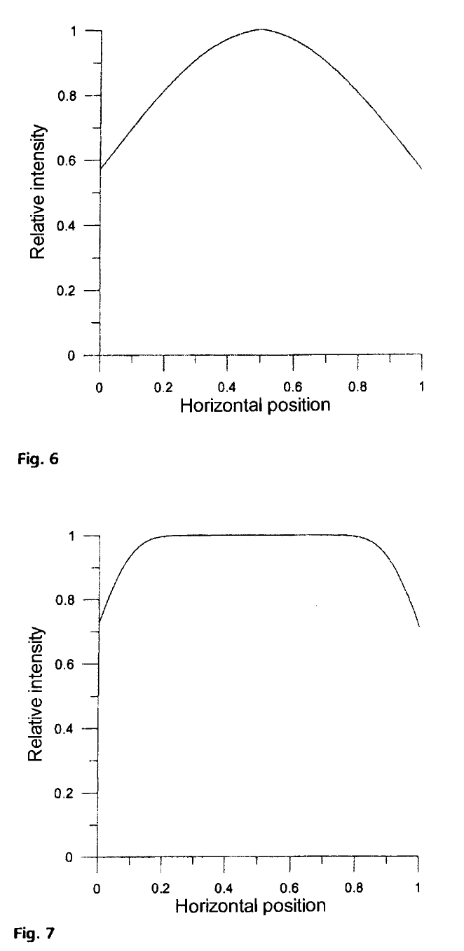

FIG. 6 shows a typical brightness characteristic in a horizontal image direction for a laser projector in accordance with FIG. 4 (conventionally); the horizontal position 0 (1) corresponds to the left-hand (right) image edge.

The three primary colors red, green and blue differ somewhat with regard to the brightness distribution, it being possible thereby for an edge discoloration to occur.

FIG. 7 shows a brightness characteristic for a smaller beam diameter (approximately ⅓) by comparison with FIG. 6; the brightness is practically constant in the image center. The edge drop is substantially smaller. The edge drop can be reduced further by fashioning the image to be more narrow through slight edge cutting.

The loss of light energy by vignetting is only 5% (example of FIG. 6: 17%).

The gradient of the edge drop becomes somewhat larger.

FIG. 8 is an illustration of the possible enlargement of the number of pixels by larger scan angles; the beam diameter on the projection screen (10) remains unchanged. The ratio between image size and beam diameter is, however, enlarged. In the case of a larger image display owing to angular changes, more pixels can be accommodated in the image with the beam diameter remaining the same. It is thereby possible to attain larger image formats (for example: QXGA).

FIG. 9 illustrates the beam direction in the upper figure; and illustrates the beam diameter in the lower figure.

The focal lengths of fiber decoupling and of the downstream lens are respectively, f_{FAK} and f. A crossing point of the beams is to be found at the location of the shutter.

Focuses are located at the fiber end, downstream of the 1st facet, and in the vicinity of the relatively far removed projection screen. The corresponding symbols for the lengths are specified.

FIG. 10 shows an exemplary embodiment of the inventive scanning device with 4 deflecting mirrors.

The above described vignetting of the beam in the case of the present design leads to a reduction of the brightness in the image, in particular the right-hand and left-hand image edges, see FIG. 6. Moreover, undesired edge discolorations come about in the image. The latter effect is explained by the differences in the brightness distribution in the light beam for the three primary colors red, green and blue. The brightness distribution of the individual colors is determined by the optical waveguide and depends, in particular, on the curvatures of the fiber, and can therefore scarcely be influenced specifically.

These said effects are substantially reduced with the aid of the invention described here. This comes about at the first facet by a sharp reduction in the beam diameter to, for example, ⅓ of the facet width. Admittedly, the facet is guided through the beam, but the beam is not cut for most of the time. When it strikes the facet too far in the edge region, the light is switched off as a consequence of the line gap, that is to say this facet region does not contribute to the imaging or does so only slightly. The beam strikes the second facet with a diameter of approximately one facet width. Since the beam is now also moved with this facet, that is to say is, as it were, frozen here, there is likewise no occurrence of interference from vignetting, or the vignetting is substantially less than in the case of a conventional laser scanner, FIGS. 4 and 5.

Surprisingly, this inventive method and the associated device render it possible to implement larger scan angles in conjunction with an unchanged polygonal mirror.

It has already been outlined above how the lens (5) downstream of the 1st facet ensures that the incidence angle onto the 2nd facet varies. The horizontal scan angle is enlarged by comparison with the conventional solution, FIG. 4, approximately by one third of the incidence angle. For example, instead of a horizontal scan angle of 26° (for a 25-face polygon) a horizontal scan angle of 35° results. The number of the mirror facets of the polygon preferably lies in the range from 10 to 50. Particularly suitable are polygons with 20 to 30 faces/mirror facets.

In order for an image format of, for example, 4:3 to remain unchanged, this necessarily entails that the vertical scan angle also be enlarged proportionately. This can be implemented without difficulty via the galvanometer mirror (9).

It is also possible for the scan angle to be capable of variable setting without the need for a change in the light power of the image.

The angular change in the incidence angle is set by a displacement of fiber decoupling, lens and the deflecting mirrors over a specific range. For example, an angular change of between 3° to 10° can be set for the incident beam. This would yield a horizontal scan angle in the range from 29° to 36°. If appropriate, this requires readjustment of the device in a way known per se. The development of one or other expensive objectives could also be dispensed with at the same time.

A further advantage becomes plain in the enlargement of the number of pixels in the image for a polygonal mirror and beam quality that are unchanged.

By enlarging the scan angles, more pixels can be accommodated in the image than when it is assumed that the beam diameter remains unchanged on the screen. The latter situation is given when the beam diameter on the 2nd facet is identical to the beam diameter on the facet in FIG. 4 (conventional scanner). Assuming that the horizontal scan angle is increased from 26° to 36°, the number of pixels in the entire image can then be virtually doubled. A substantial resolution gain is then obtained in conjunction with the same beam quality.

The following explanations and examples are intended to serve the purpose of more effectively illustrating the optical beam path.

The optical beam path can be only imprecisely recognized from FIG. 1. Let us consider FIG. 9 in this regard.

However, by way of simplification and without any restriction in generality, it is assumed that β=0 (see FIGS. 2 and 3).

The following quantities are prescribed for the further considerations:

Hi, i=0, . . . , 5: maximum spacing of the light beams from one another at position i

αi, i=0, . . . , 5: maximum angle between the light beams at position i

β: vertical angle with reference to polygon facets, see FIGS. 3 and 3

θi, i=0, . . . , 5: divergence angle of the light beam in the far field at position i

Di, i=0, . . . , 5: the diameter at position i

Positions i: 1: fiber end
3: fiber decoupling (FAK)
4a: 1st facet
5: lens or lens system
8: shutter
4b: 2nd facet

Let us firstly calculate a relationship between the scan angles downstream of the 1st and the 2nd mirror facets (4a; 4b):

$$Given {α}_{5} = {α}_{4 a} η with η + \frac{{L}_{4 α}}{{L}_{5}} \qquad ( 1 )$$

the result is:

$${α}_{4 b} = ( {α}_{4 a} + {α}_{5} ) = {α}_{4 a} ( 1 \qquad ( 2 )$$

Because

$$\frac{1}{f} = \frac{1}{{L}_{4 a}} + \frac{1}{{L}_{5}} \qquad ( 3 )$$

in equation (1), it follows that:

$${L}_{4 a} = f ( 1 + η ) and {L}_{5} = f ( 1 + \frac{1}{η} ) \qquad ( 4 )$$

The relationship:

$${D}_{4 a} = {D}_{5} \frac{{L}_{4 a} - {L}_{4 a}^{′}}{{L}_{4 a}^{′}} \qquad ( 5 )$$

holds for the beam diameter.

Adapting the approximations D_{4b}≈D₅ and L′₂≈f and equation (3) as well as the assumption that the shutter does not effectively reduce the beam diameter, the following relationship results between the beam diameters at the 1st and 2nd mirror facets (4a; 4b):

$${D}_{4 a} \approx {D}_{4 b} η \qquad ( 6 )$$

L₈ is calculated using the relationship:

$${L}_{8} = {L}_{5} \frac{{H}_{4 b}}{{H}_{5}} \qquad ( 7 )$$

with the aid of the freezing condition for the beam at the second facet:

H_{4b}=B (8)

B being equal to the displacement of the 2nd facet perpendicular to the beam direction, while a line is being scanned from left to right in the image.

Furthermore it holds that:

$${H}_{5} = 2 {L}_{4 a} tan \frac{{α}_{4 a}}{2} = 2 f ( 1 + η ) tan \qquad ( 9 )$$

Because of equations (4, 7-9):

$${L}_{8} \approx \frac{B}{2 ηtan \frac{{α}_{4 a}}{2}} \qquad ( 10 )$$

It is thereby ensured that the beam is also moved as required (‘frozen’).

How must the fiber decoupling be set? The beam diameter D5 is to be identical to the beam diameter at the fiber decoupling (FAK) of the conventional laser scanner so that the same beam diameter is present at the screen; compare remarks relating to FIG. 8. In this case, θ₁ is prescribed by the optical fiber.

It must therefore hold that:

$${f}_{FAK} tan {θ}_{1} = j or \text{:} \frac{{θ}_{1}}{{θ}_{3}} \approx \frac{f}{{f}_{FAK}} . \qquad ( 11 )$$

Because:

$$\frac{{θ}_{1}}{{θ}_{3}} = \frac{{L}_{1} + {L}_{4 a} - {L}_{4 a}^{′}}{{L}_{1}} \qquad ( 12 )$$

and:

$$\frac{1}{{f}_{FAK}} = \frac{1}{{L}_{1}} + \frac{1}{{L}_{3} + {L}_{4 a} - {L}_{4 a}^{′}} \qquad ( 13 )$$

it follows that: L₃+L₄ₐ−L′₄ₐ=f+f_{FAK} (14)

And it follows, finally, that:

$${L}_{1} - {f}_{FAK} ( 1 + \qquad ( 15 )$$

and that:

$${L}_{3} \approx {f}_{FAK} + f \qquad ( 16 )$$

The following exemplary embodiments to be mentioned to this end:
a) the following are given: η=¼, f_{FAK}=40 mm, f=80 mm, D_{4b}=5 mm, α₄ₐ=26°, β=0°, B=4.3 mm

It follows therefrom that:
α_{4b}=34.7°, D₄ₐ=1.67 mm, H₅=49.3 mm, L₁=60 mm,
L₃=93.3 mm, L₄ₐ=106.7 mm, L′₄ₐ=80 mm,
L₅=320 mm, L₈=26.0 mm
b) the following are given: η=⅕, f_{FAK}=40 mm, f=80 mm, D_{4b}=5 mm, α₄ₐ=26°, β=0°, B=4.0 mm

It follows therefrom that:
α=31.2°, D₄ₐ=1.00 mm, H₅=44.3 mm, L₁=60 mm,
L₃=104 mm, L₄ₐ=96 mm, L′₄ₐ=80 mm,
L₅=480 mm, L₈=43.3 mm
c) the following are given: η=⅛, f_{FAK}=50 mm, f=80 mm, D_{4b}=5 mm,
α₄ₐ=26°, β=0°, B=4.0 mm

It follows therefrom that:
α_{4b}=29.3°, D₄ₐ=0.63 mm, H₅=41.6 mm, L₁=81 mm,
L₃=120 mm, L₄ₐ=90 mm, L′₄ₐ=80 mm,
L₅=720 mm, L₈=69.3 mm.

### LIST OF REFERENCE SYMBOLS

1 Optical fiber
2 Light beam
3 Fiber decoupling unit
4 Polygonal mirror
4a Facet mirror a
4b Facet mirror b
5 Lens or lens system
6 Deflecting mirror 1
7 Deflecting mirror 2
8 Shutter
9 Galvanometer mirror
10 Projection screen/surface
11 Deflecting mirror 3
12 Deflecting mirror 4

1-18. (canceled)

19. A method for projecting an image onto a projection surface, the image being constructed in a linewise fashion with the aid of a modulated light beam, the method comprising
using at least one light source that emits a light beam whose intensity can be varied;
coupling to the light source to the at least one optical fiber unit;
guiding the at least one light beam leaving the at least one optical fiber unit with a fiber decoupling unit located downstream of the at least one optical fiber unit, the decoupling unit being arranged along the optical axis such that said at least one light beam is consequently guided via a deflecting device with a polygonal mirror, the at least one light beam striking first and second mirror facets of the polygonal mirror in succession in such a way that said at least one light beam intersects the second mirror facet at the same location.

20. The method as claimed in claim 19, wherein a diameter with which the at least one light beam strikes a first mirror facet of the polygonal mirror is dimensioned such that the at least one light beam is not cut at edges of the first mirror facet.

21. The method as claimed in claim 19, wherein a diameter with which the at least one beam strikes a first mirror facet of the polygonal mirror is dimensioned such that the brightness at the image edge of the projection image does not drop below a value of 70% of brightness at a center of the projection image.

22. The method as claimed in claim 19, wherein the diameter with which the at least one light beam strikes the second mirror facet of the polygonal mirror is dimensioned such that said at least one light beam produces a light spot as small as possible on the projection screen.

23. The method as claimed in claim 19, wherein the diameter with which the at least one light beam strikes the second mirror facet of the polygonal mirror is dimensioned such that said at least one light beam produces a larger scan angle than at the first mirror facet.

24. The method as claimed in claim 19, wherein the at least one light beam is guided sequentially inside the deflecting device via a suitable lens or lens system and a suitable number of deflecting mirrors such that, downstream of the first mirror facet, such that the at least one light beam is fed to the second mirror facet so as to effect an enlargement of the scan angle.

25. The method as claimed in claim 24, further comprising a shutter or shutter system such that the at least one light beam is fed to the second mirror facet so as to effect an enlargement of the scan angle.

26. The method as claimed in claim 24, wherein the sequence in which the at least one light beam is guided by the lens or lens system and the suitable number of deflecting mirrors can be fashioned as desired.

27. The method as claimed in claim 24, wherein the number of the deflecting mirrors used corresponds to an even number.

28. The method as claimed in claim 19, further comprising guiding the at least one light beam by a galvanometer mirror downstream of the second deflection of the mirror facets of the polygonal mirror, and wherein said galvanometer mirror guides the at least one light beam onto the projection screen in order to produce an image.

29. The method as claimed in claim 19, further comprising injecting an IR signal into the beam path by a dichroic mirror before the light beam strikes the first mirror facet of the polygonal mirror.

30. A deflecting device for projecting an image onto a projection screen, the image being constructed in linewise fashion with the aid of a modulated light beam, comprising:
at least one light source that emits a light beam that can be varied in intensity;
optical fiber units and a fiber decoupling unit coupled to the light source;
a polygonal mirror with a suitable number of mirror facets downstream from the fiber decoupling unit;
downstream optical elements, including a lens or lens system;
a suitable number of deflecting mirrors;
a downstream shutter or shutter system;
the deflecting mirrors being positioned relative to one another in their arrangement and number such that they guide the light beam onto the mirror facets of the polygonal mirror for a second time, the second mirror facets being intersected at the same location; and
further comprising a galvanometer mirror positioned such that it guides the light beam onto the projection screen.

31. The deflecting device as claimed in claim 30, wherein the facet faces of the polygonal mirror are inclined with reference to their rotation axis.

32. The deflecting device as claimed in claim 30, wherein at least two deflecting mirrors are used.

33. The deflecting device as claimed in claim 32, comprising an even number of deflecting mirrors.

34. The deflecting device as claimed in claim 30, wherein the lens or lens system is arranged immediately downstream of the polygonal mirror and upstream of the deflecting mirrors.

35. The deflecting device as claimed in claim 30, wherein the lens or lens system is arranged between the deflecting mirrors.

36. The deflecting device as claimed in claim 34, wherein the lens or lens system has at least a focal length such that an error owing to the variable spacing from the facet surface remains negligible.

37. The deflecting device as claimed in claim 30, further comprising a fiber decoupling unit arranged upstream of the deflecting device positioned relative to the components of the deflecting device such that the deflecting device effects an angular change in the incidence angle.
